(19) United States
(12) Patent Application Publication
(10) Pub. No.: US 2011/0318969 A1
(43) Pub. Date: Dec. 29, 2011

(54) CONNECTOR

(75) Inventors: Yoko MURATA, Kawasaki (JP); Akira TAMURA, Kawasaki (JP)

(73) Assignee: FUJITSU LIMITED, Kawasaki-shi (JP)

(21) Appl. No.: 13/071,667

(22) Filed: Mar. 25, 2011

(30) Foreign Application Priority Data
Jun. 24, 2010 (JP) 2010-143254

(51) Int. Cl. H01R 24/20

(52) U.S. Cl. 439/660

(57) ABSTRACT

A connector fixable on a board comprises a plurality of plug contacts and a plurality of receptacle contacts, wherein the plug contacts and the receptacle contacts are alternately arranged on a fit plane.

### CROSS-REFERENCE TO RELATED APPLICATIONS

This application is based upon and claims the benefit of priority of the prior Japanese Patent Application No. 2010-143254, filed on Jun. 24, 2010, the entire contents of which are incorporated herein by reference.

### FIELD

The present invention relates to a connector fixable on a board.

### BACKGROUND

Conventionally, there is widely used a connector which is mounted on a circuit board such as printed circuit board and which connects the circuit board and other electric circuit.

For example, there is described in Japanese Laid-Open Patent Publication No. 2002-93501 a connector structure in which a groove substantially perpendicular to the bottom of a female connector is formed on a side of the female connector, a female contact is provided inside the groove, a male connector is moved closer to the female connector to be substantially perpendicular to each other, and the male contact is inserted into the groove in the middle to engage with the female contact, thereby contacting both the contacts.

### SUMMARY

In a conventional connector, a female receptacle connector and a male plug connector are present and each connector is designed independently. Further, when the connectors are used to connect a circuit board and other electric circuit, both the receptacle connector and the plug connector are used and the number of components of a device mounting the connectors thereon increases.

The discussed connector is a connector fixable on a board comprising a plurality of plug contacts and a plurality of receptacle contacts. The plug contacts and the receptacle contacts are alternately arranged on a fit plane.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

Referring now to the attached drawings which form a part of this original disclosure:

FIG. 1 is a perspective view illustrating one example of a connector;

FIG. 2 is a side view of the connector illustrated in FIG. 1;

FIG. 3A is a structure diagram of a plug contact;

FIG. 3B is a structure diagram of a receptacle contact;

FIG. 4 is a diagram illustrating a state in which two boards are mutually connected in parallel;

FIG. 5 is a diagram illustrating a state in which the plug contact and the receptacle contact are fit to each other;

FIG. 6 is a diagram illustrating a state in which two boards are connected to be perpendicular to each other; and

FIG. 7 is a perspective view illustrating a connector according to a first modification.

### DESCRIPTION OF EMBODIMENT

### Embodiment

A connector fixable on a board will be described below with reference to an embodiment.

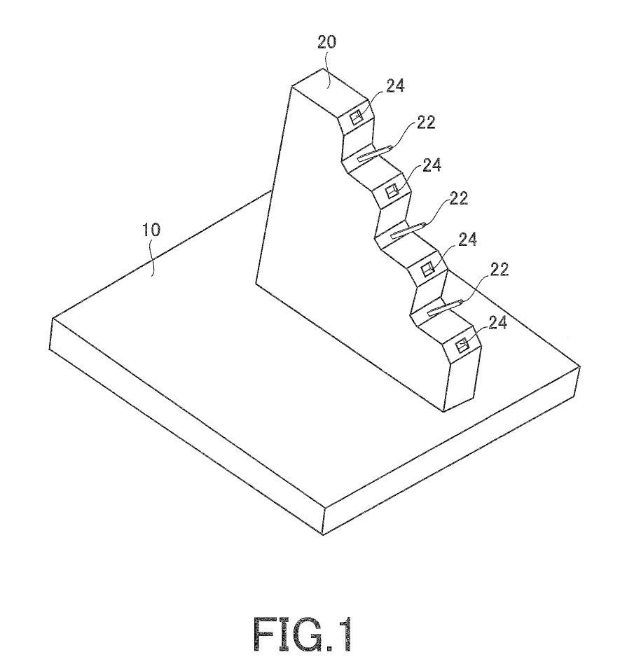

At first, a schematic structure of a connector according to the present embodiment will be described with reference to FIG. 1. FIG. 1 is a perspective view illustrating one example of the schematic structure of the connector according to the present embodiment. As illustrated in FIG. 1, the connector 20 according to the present embodiment is fixed on a board 10 such as printed circuit board. The connector 20 includes a plurality of plug contacts 22 and a plurality of receptacle contacts 24. The exemplary connector 20 illustrated in FIG. 1 includes three plug contacts 22 and four receptacle contacts 24. The plug contacts 22 and the receptacle contacts 24 are alternately arranged as illustrated in FIG. 1.

The method for fixing the connector 20 on the board 10 is not particularly limited to the foregoing. For example, the connector 20 can be fixed on the board 10 via throughhole mounting or pressure mounting.

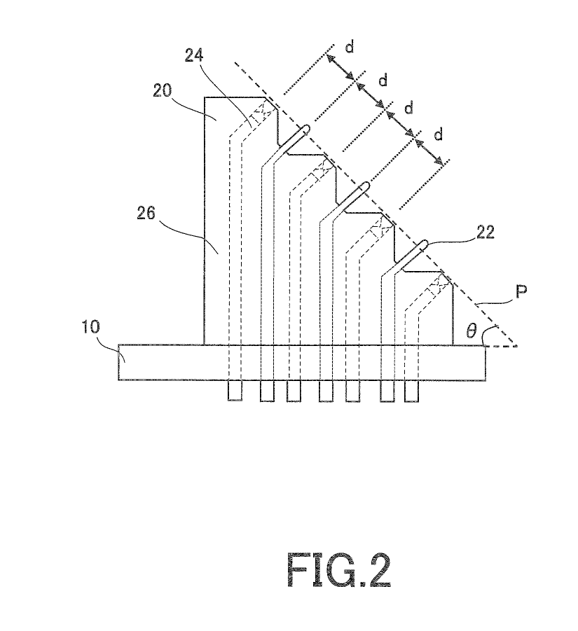

Next, a shape of the connector 20 will be described in detail with reference to FIG. 2. FIG. 2 is a side view of the connector 20 illustrated in FIG. 1. P in FIG. 2 indicates a fit plane of the connector 20. The fit plane P is perpendicular to a direction in which the plug contacts 22 extend. As illustrated in FIG. 2, the plug contacts 22 and the receptacle contacts 24 are alternately arranged on the fit plane P.

Since the plug contacts 22 and the receptacle contacts 24 penetrate through a housing 26 of the connector 20, the board 10 can be connected to other electric circuit. Detailed shapes of the plug contacts 22 and the receptacle contacts 24 will be described later.

The fit plane P of the connector 20 according to the present embodiment is tilted relative to the board 10 on which the connector 20 is fixed. In FIG. 2, an angle formed between the fit plane P of the connector 20 and the board 10 is indicated as θ. In the present embodiment, the angle θ is 45 degrees.

The plug contacts 22 and the receptacle contacts 24 according to the present embodiment are arranged at equal intervals on the fit plane P. In FIG. 2, a distance between adjacent plug contact 22 and receptacle contact 24 is indicated as d.

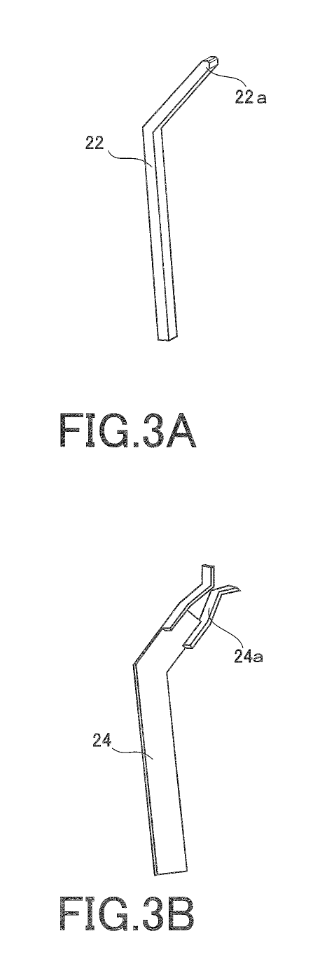

The structures of the plug contact 22 and the receptacle contact 24 will be described, respectively, with reference to FIGS. 3A and 3B. FIG. 3A is a structure diagram of the plug contact 22 and FIG. 3B is a structure diagram of the receptacle contact 24. Both the plug contact 22 and the receptacle contact 24 are made of a metallic material excellent in conductivity. A contact part 22a of the plug contact 22 and a contact part 24a of the receptacle contact 24 are formed such that the contact part 22a and the contact part 24a are fit to each other. A state in which the plug contact 22 and the receptacle contact 24 are fit to each other will be described below.

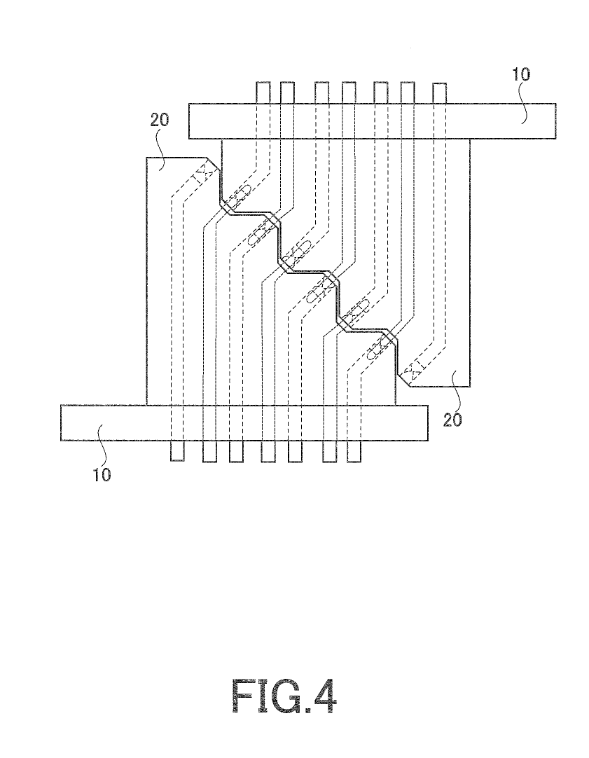

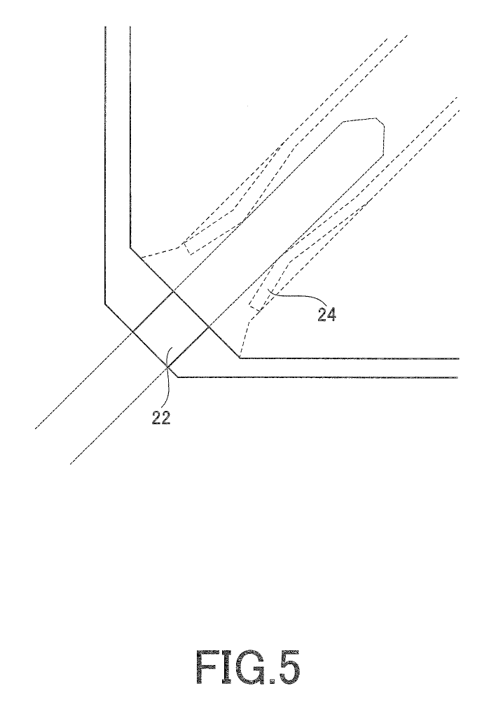

With reference to FIGS. 4 and 5, a state in which two boards 10 are connected to each other in parallel will be described below. FIG. 4 is a diagram illustrating a state in which the connectors 20 having the same shape are fixed on two boards 10, respectively, and the two connectors 20 are connected to each other such that the two boards 10 are in parallel to each other. FIG. 5 is an enlarged diagram of FIG. 4, where the two connectors 20 are connected to each other and the plug contacts 22 and the receptacle contacts 24 are fit to each other.

Since the connector 20 according to the present embodiment includes a plurality of plug contacts 22 and a plurality of receptacle contacts 24 which are alternately arranged, the two connectors 20 having the same shape can be connected to each other as illustrated in FIG. 4. In other words, since the plug contacts 22 of one connector 20 are fit to the receptacle contacts 24 of the other connector 20, a receptacle connector and a plug connector do not need to be separately provided. Thus, the connector 20 according to the present embodiment is used to reduce the number of components.

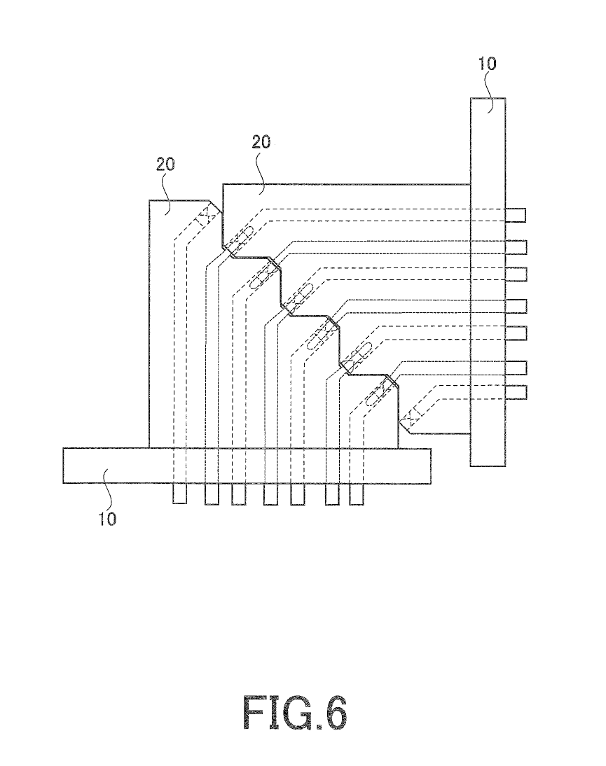

With reference to FIG. 6, a state in which two boards 10 are mutually connected to be perpendicular to each other will be described below. FIG. 6 is a diagram illustrating a state in which the connectors 20 having the same shape are fixed on two boards 10, respectively, and the two connectors 20 are mutually connected such that the two boards 10 are perpendicular to each other. In the connector 20 according to the present embodiment, an angle formed between the fit plane P and the board 10 is 45 degrees. Thus, the connectors 20 having the same shape are used thereby not only to mutually connect the two boards 10 in parallel as illustrated in FIG. 4 but also to connect the two boards 10 to be perpendicular to each other as illustrated in FIG. 6. In this manner, since the two boards 10 can be mutually connected to be in parallel with or perpendicular to each other, when the connector 20 according to the present embodiment is used for connection, a degree of freedom of design can be enhanced.

As described above, the connector 20 according to the present embodiment includes a plurality of plug contacts 22 and a plurality of receptacle contacts 24, and the plug contacts 22 and the receptacle contacts 24 are alternately arranged on the fit plane P. Therefore, the connector 20 according to the present embodiment is used thereby to reduce the number of component.

There is described in the above embodiment the example in which the connector 20 includes three plug contacts 22 and four receptacle contacts 24, but the number of plug contacts 22 and the number of receptacle contacts 24 are not limited thereto, and any number of contacts may be employed. As described with reference to FIGS. 4 and 6, the receptacle contacts 24 are preferably more in number than the plug contacts 22 in order that two connectors 20 having the same shape are used to connect two boards 10 in parallel with or perpendicular to each other.

### First Modification

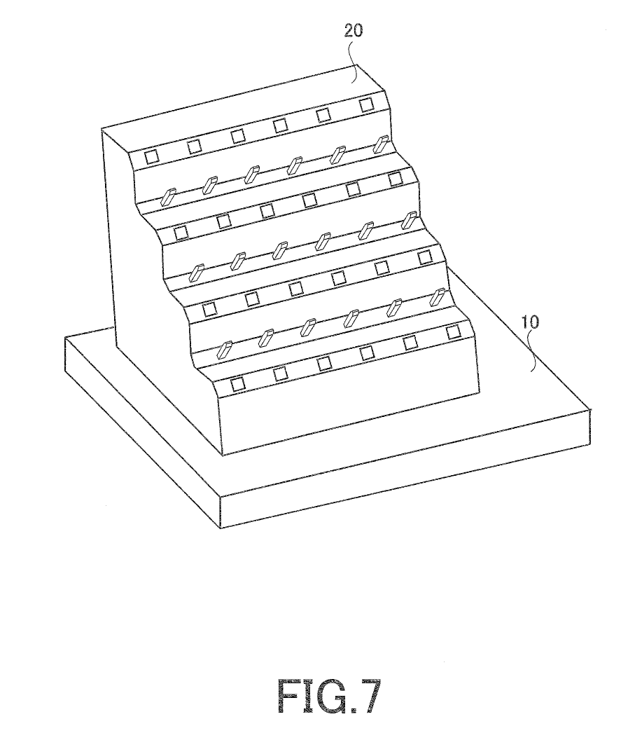

In the embodiment described with reference to FIG. 1, there is described the example in which a plurality of plug contacts 22 and a plurality of receptacle contacts 24 are alternately arranged along the fit plane P of the connector 20 in one line, but the plug contacts 22 and the receptacle contacts 24 may be arranged in multiple lines. A connector 20 according to first modification will be described below with reference to FIG. 7.

FIG. 7 is a perspective view illustrating one example of a schematic structure of the connector 20 according to the present modification. As illustrated in FIG. 7, the connector 20 according to the first modification is equivalent to the shape in which six connectors are mutually coupled in parallel as described in FIG. 1. The structures of the plug contact 22 and the receptacle contact 24 are the same as those in the above embodiment. As in the connector 20 according to the present modification, even when a plurality of plug contacts 22 and a plurality of receptacle contacts 24 are arranged in multiple lines, two connectors 20 having the same shape are used thereby to reduce the number of components.

### Second Modification

In the embodiment described with reference to FIG. 1, there is described the case in which the angle θ formed between the fit plane P of the connector 20 and the board 10 is 45 degrees, but the angle θ formed between the fit plane P and the board 10 is not limited thereto.

Even if the angle θ is other than 45 degrees, the connectors 20 having the same shape are fixed on two boards 10, respectively, thereby to connect the two connectors 20 such that the two boards 10 are parallel to each other as described with reference to FIG. 4. Thus, as in the present modification, even when the angle θ is other than 45 degrees, two connectors 20 having the same shape are used thereby to reduce the number of components.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present inventions have been described in detail, it should be understood that the various changes, substitutions, and alternations could be made hereto without departing from the spirit and scope of the invention.

What is claimed is:

1. A connector fixable on a board comprising:
a plurality of plug contacts; and
a plurality of receptacle contacts, wherein
the plug contacts and the receptacle contacts are alternately arranged on a fit plane.

2. The connector according to claim 1, wherein the fit plane is tilted relative to the board on which the connector is fixed.

3. The connector according to claim 2, wherein the fit plane is tilted at 45 degrees relative to the board on which the connector is fixed.

4. The connector according to claim 1, wherein the plurality of plug contacts and the plurality of receptacle contacts are arranged on the fit plane at equal intervals.
